(19) United States
(12) Patent Application Publication
(10) Pub. No.: US 2011/0232029 A1
(43) Pub. Date: Sep. 29, 2011

(54) ADJUSTABLE LOCKING DEVICE FOR WINDOWS AND DOORS

(76) Inventor: Christian Hartgens, Broomfield, CO (US)

(21) Appl. No.: 12/888,374

(22) Filed: Sep. 22, 2010

Related U.S. Application Data
(63) Continuation-in-part of application No. 29/356,636, filed on Mar. 1, 2010, now abandoned.

(51) Int. Cl. E05F 5/00

(52) U.S. Cl. 16/82

(57) ABSTRACT

A locking device for keeping a window or sliding door from opening beyond a predetermined limit includes telescoping inner and outer members. A fastening mechanism selectively locks the inner member and the outer member. In one embodiment, the outer member has a first lateral side with a series of holes on one side spaced apart at a first distance and the second lateral side with a series of holes spaced apart at a second distance. The holes allow fine length adjustment of the locking device. The fastening mechanism is press-fit inside the inner member and includes a push pin to lock the inner member and outer member. The push pin is integrated on a c-shaped clip to spring-bias the push pin in place within the inner member. In another embodiment, the fastening mechanism extends from the inner member and rotation of the inner member locks enables the fastening mechanism to lock against the outer member.

### RELATED APPLICATIONS/PRIORITY CLAIM

This application is a continuation-in-part of design application number 29/356,636 filed Mar. 1, 2010.

### FIELD OF THE INVENTION

The present invention relates to devices for locking and blocking windows and doors.

### BACKGROUND OF THE INVENTION

During the warmer months, many like to leave doors and windows open for ventilation. Open doors and windows, however, make entry points for burglars and other uninvited guests. Further, young children may find crawling through an open entryway attractive.

Many window manufacturers include fixed screens with the windows sold. A fixed screen covers cover a window opening. Unfortunately, fixed screens provide only for limited security because they are easily compromised.

A variety of ways to lock a partially opened window or door have been developed to provide security to home occupants. Some are difficult to operate, particularly for those with severe arthritis or weak hands.

US Pub. No. 20090173012 to Luca describes an adjustable restraining stop assembly that permits a residential double hung window to be locked in a partially opened position to permit ventilation through the partial opening. The stop includes an outer tube with a telescoping inner tube. The outer tube is mounted to a window sash by a removable fixation device, such as a mounting hook and loop arrangement. A convenience knob is attached near the distal end of the inner tube. Adjustment is set by placing a desired hole of a plurality of holes in the telescoping inner tube in registration with a single hole in the outer tube and then inserting the end of a fastener, such as a cotter pin, locking both tubes together.

U.S. Pat. No. 4,318,559 discloses a device that is screwed into a window frame, sash, or track and has a hinge that flexes when a window is open or closed. Attachment of this device requires the use of tools and defaces the property. Many don't wish to deface the window or door jam by mounting hardware thereon. Further the hinge obstructs the view through a portion of the window when the hinge flexes.

U.S. Pat. No. 6,141,912 discloses a device that extends laterally across an open window or door. However extending a device laterally across an open window may obstruct the view and prevent use of the window as an exit in the event of emergencies.

One limitation of existing locking devices is that the length adjustment may not always be precisely fine-tuned. Another limitation is that mounting a locking device by using fasteners against a window frame, or modifying a sash, are undesirable. Some existing locking devices are not senior-friendly and may be difficult to operate for those with arthritis of the hand, or other condition that decreases dexterity. What is desired is an improved locking device.

### SUMMARY OF THE INVENTION

The present invention provides an adjustable locking device for various types of windows and doors. The locking device is useful with single-hung windows, double-hung windows, sliding windows and sliding doors. The locking device permits them to remain partially open, but securely locked. It can be appreciated that the present invention can also be used as a secondary locking mechanism when windows and sliding doors are to be locked shut. For the purposes of this invention, the term “locking device” should be broadly understood to include any device for restricting movement between portions of a window or door.

The locking device includes an outer member having a first lateral side and a second lateral side that opposes the first lateral side. The first lateral side has series of holes spaced apart at a first distance. The second lateral side has a series of holes spaced apart at a second distance. The second distance being half of the first distance to allow fine length adjustment of the locking device.

The locking device also has an inner member in sliding engagement with the outer member. The inner member has at least one lock hole for alignment with the series of holes in the first lateral side and second lateral side of the outer member.

The locking device further includes a first end cap fitted on end of the inner member and a second end cap fitted on one end of the outer member. The first end cap including a foot extending beyond the first lateral side of the outer member when the inner member and outer member are engaged. The foot is configured to enable operation of the locking device in windows with, and without, gaps.

To lock the locking device at a particular length, the locking device includes a fastening mechanism attached inside the inner member. The fastening mechanism includes a push pin, which is capable of simultaneously extending through the lock hole of the inner member and one hole of the outer member.

The push pin of the present invention is self contained, lacking sharp protrusions that can interfere with handling of the locking device. The push pin is resilient and should remain in place even after extended use. The push pin is spring loaded to make makes the locking device more secure due to the pressure the spring exerts on the pin. The spring loading of the push pin makes telescoping the inner member with respect to the outer member a controlled movement, to inhibit the inner member from separating from the outer member.

The device can be adjusted in intervals to lock a window or sliding door from opening beyond a set limit. This allows the door or window to facilitate ventilation while providing for security. Particularly, The device that blocks windows and sliding doors from being forced open by trespassers, effectively preventing them from gaining access into a home. Another benefit of the device is to provide safety to children by regulating potential exits from the home.

Designed to replace wooden dollies, wood blocks, sticks, and other inferior methods, the present invention sits in or on the track of a window or sliding door, or against its sash, or against the pane. The head of the device is wedged into a corner of the frame, or against the frame of the window or sliding door. This corner of the frame serves as an immovable object.

For example, when the device is fixed against a window frame in operation and the window is raised, the window contacts the device. The device limits further opening of the window. The device is held securely in a track, against the sash, or pane by some form of removable bonding method that secures the device firmly in place. This allows the device to remain securely affixed in its position despite the position of the window or sliding door. This also allows the device to be removed and replaced at will. The device can also be secured by a permanent method of choice.

### BRIEF DESCRIPTION OF THE DRAWINGS

The present invention will be better understood when consideration is given to accompanying drawings. The invention is not limited to the precise embodiments shown in drawings in which:

FIG. 1 is a perspective view of an embodiment of the invention.

FIG. 2 is a top plan view of the invention.

FIG. 3 is a right side elevation view of the invention.

FIG. 4 is a bottom plan view of the invention.

FIG. 5 is a front elevation view of the invention.

FIG. 6 is a rear elevation view of the invention.

FIG. 7 is an exploded perspective view of the invention.

FIG. 8 is a perspective view of an alternate embodiment of the invention.

### DETAILED DESCRIPTION OF THE INVENTION

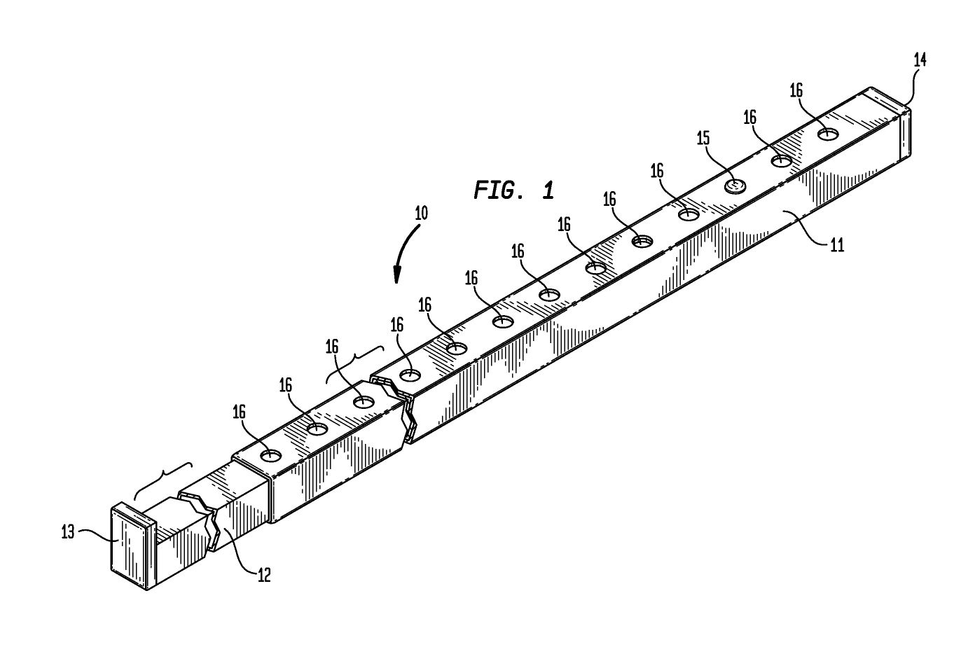

FIG. 1 shows a locking device 10 having an outer member 11, and inner member 12. The inner member 12 has an end with an end cap 13. The end cap 13 has a rectangular shape forming a foot, which is useful to limit opening of windows and doors having a significant gap between a window sash and frame, for example.

The outer member 11 has an end cap 14 having a square shape. End caps 13 and 14 protect window or door frames during use. The outer member 11 has a first lateral side and a second lateral side that opposes the first lateral side. The first lateral side has series of holes spaced apart at a first distance. The second lateral side has a series of holes spaced apart at a second distance (see FIG. 4). The second distance is relatively greater than the first distance to allow for faster adjustment of the locking device. The first distance is relatively less than the second distance to allow for finer adjustment.

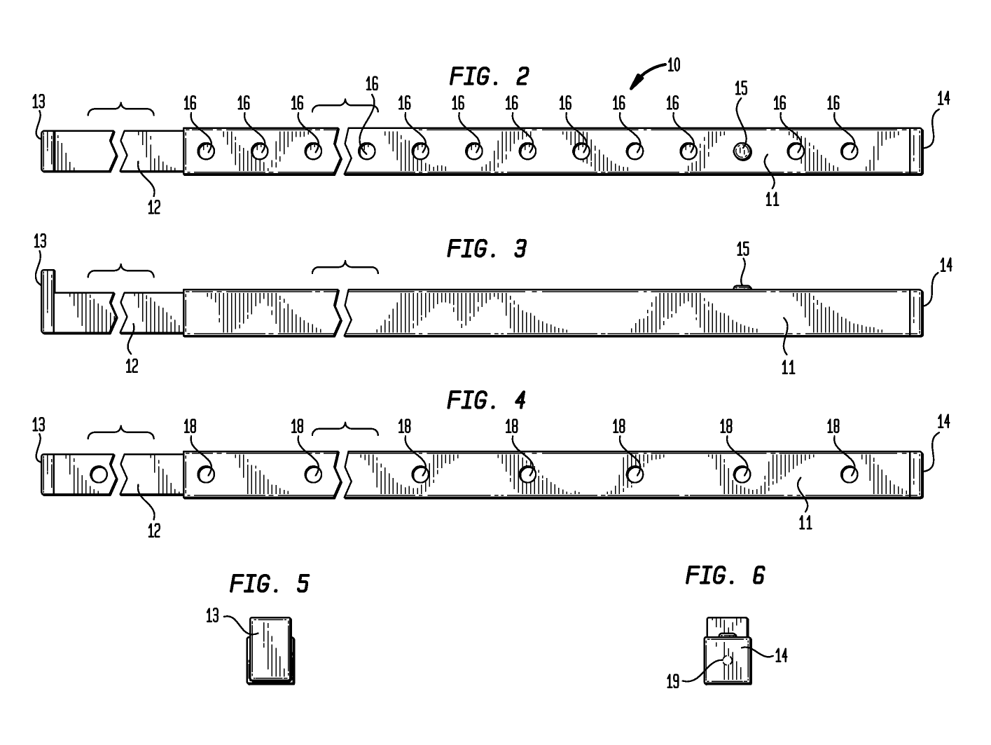

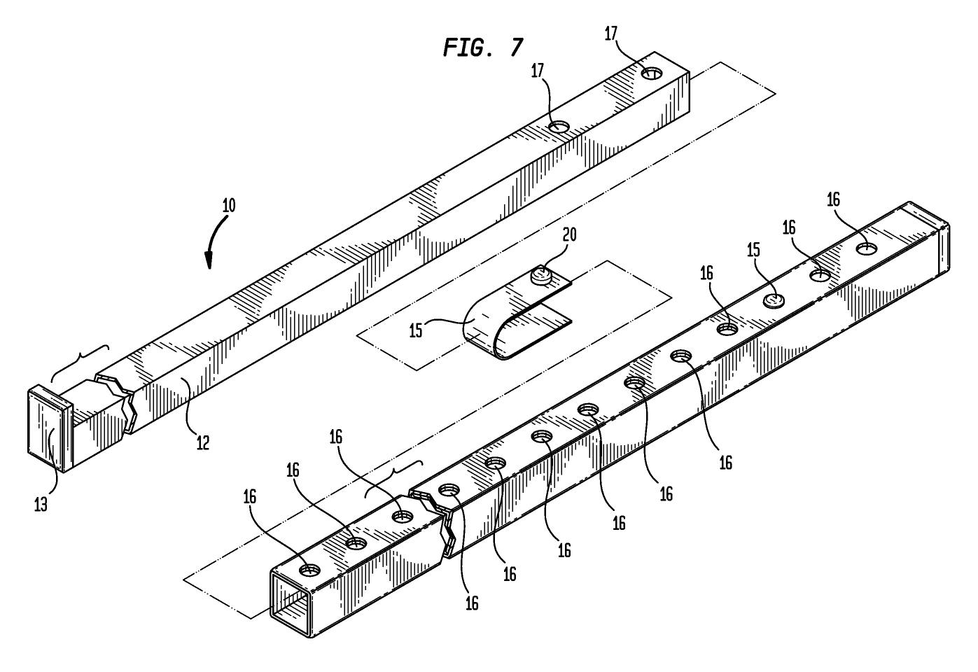

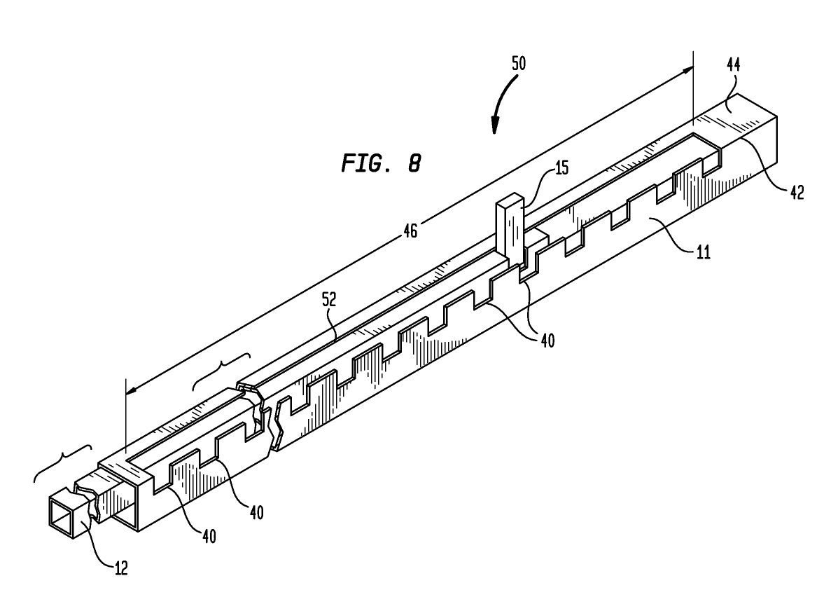

The locking device 10 also has an inner member 12 in sliding engagement with the outer member 11. The inner member 12 has at least one lock hole 17 (see FIG. 7) for alignment with the series of holes 16 or 18 of either the first lateral side and second lateral side of the outer member (see FIG. 2 and FIG. 4).

To lock the locking device at a particular length, the locking device includes a fastening mechanism 15 (FIG. 7) attached inside the inner member 11. The fastening mechanism 15, in one embodiment of the invention, includes a push pin 20, which is capable of simultaneously extending through the lock hole 17 of the inner member and one hole 16 of the outer member.

FIG. 2 shows locking device 10 with outer member 11, and inner member 12. A header end-cap 14, attached to the front of the outer member. A footer end-cap 13, attached to the rear of the inner member. A series of holes 16, line the top surface of the outer member. A spring-loaded push pin 15 is housed within the inner member, protruding through the inner member hole 17, and the outer member hole 16.

FIG. 3 shows locking device 10 with outer member 11, and inner member 12. A header end-cap 14, attached to the front of the outer member. A footer end-cap 13, attached to the rear of the inner member. A spring-loaded push pin 15 is housed within the inner member, protruding through the inner member hole 17, and the outer member hole 16.

FIG. 4 shows locking device 10 with outer member 11, and inner member 12. A header end-cap 14, attached to the front of the outer member. A footer end-cap 13, attached to the rear of the inner member. A series of holes 18, line the bottom surface of the outer member. Adjustments are made by pressing in the spring-loaded push pin 15, pulling or pushing the inner member 12, to line up the spring-loaded push pin 15 to the desired outer member hole 18, and allowing the spring-loaded push pin 15, to de-press and protrude through the chosen outer member hole 18, which locks the two members together at the desired length.

FIG. 5 shows the end-cap 13 and FIG. 6 shows header end-cap 14, with hole 19. Hole 19, is used to accommodate a secure bonding method including a screw.

FIG. 7 shows locking device 10 with outer member 11, and inner member 12. A header end-cap 14, attached to the front of the outer member. A footer end-cap 13, attached to the rear of the inner member. A series of holes 16, line the top surface of the outer member. A spring-loaded push pin 15, used to lock the outer member 11, and the inner member 12, together. A set of holes 17, on top surface of inner member used to secure the spring-loaded push pin within the cavity of the inner member 12.

FIG. 8 shows locking device 50, having a plurality of gaps 40 aligned along an edge 42 of the outer member 11. The outer member 11 has a side 44 adjacent the edge 42 with a length 46 and an opening 48 extending along a portion of its length. The opening 48 is defined by a periphery 52. A portion of the periphery 52 defines the gaps 40.

The fastening member 15 is affixed to the inner member 12, and protrudes perpendicularly from the inner member 12, extending beyond the gaps 40. The inner member 12 slidably engages the outer member 11 and is axially rotatable with respect to the outer member 11. A spring, such as a coil spring, may be interposed between the inner member 12 and the outer member 11 to dampen axial rotation and sliding movements between the members 11 and 12, or to bias the inner member 12 into a locking position with respect to the outer member 11

Axial rotation of the inner member 12 with respect to the outer member 11 engages the fastening member 15 against the periphery 52, in a single gap 40, to lock the inner member 12 with respect to the outer member 11.

The locking device 50 has several advantages. In particular it is a senior-friendly device, designed particular for those with arthritis or those having weakened grip. It is quickly adjustable and easily removable from a window frame.

The present invention is disclosed in terms of various embodiments. The description and drawings are intended by way of example only. The true scope of the present invention, however, is expressed by the appended claims.

What is claimed is:

1. A locking device, comprising:
an outer member having a first lateral side and a second lateral side that opposes the first lateral side, the first lateral side has series of holes spaced apart at a first distance, the second lateral side has a series of holes spaced apart at a second distance, the second distance being less than the first distance to allow fine length adjustment of the locking device;
an inner member in sliding engagement with the outer member, the inner member has a lock hole for alignment with the series of holes in the first lateral side and second lateral side of the outer member;
a fastening mechanism press-fit inside the inner member, the fastening mechanism includes a push pin, which is capable of simultaneously extending through the lock hole of the inner member and one hole of the outer member.

2. A device as set forth in claim 1, wherein the inner member and the outer member are block-shaped.

3. A device as set forth in claim 1, wherein the inner member and the outer member are block-shaped, having a square cross-section.

4. A device as set forth in claim 1, wherein the device has an axis, the push pin extends through one of the holes of the first lateral side, the inner member and the outer member are separable upon engagement of the push-pin to enable axial rotation of the outer member with respect to the inner member so that re-engaging the outer member with the inner member aligns the push pin with one hole of the second lateral side of the inner member.

5. A device as set forth in claim 4, wherein the fastening device includes a spring loaded clip for pressing biasing the push pin through the lock hole, whereby depression of the push pin towards the axis enables the outer member to slide with respect to the inner member.

6. A device as set forth in claim 4, wherein the fastening device includes a spring loaded clip for pressing biasing the push pin through the lock hole, the clip having a C-shaped cross section.

7. A device as set forth in claim 4, wherein the fastening device includes a spring loaded clip for pressing biasing the push pin through the lock hole, the clip having a C-shaped cross section and two ends, the push pin being configured on one end of the clip.

8. A locking device, comprising:
an outer member, having a first lateral side and a second lateral side that opposes the first lateral side, the first lateral side has series of holes spaced apart at a first distance, the second lateral side has a series of holes spaced apart at a second distance, the second distance being less than the first distance to allow fine length adjustment of the locking device;
an inner member having two ends, and being in a sliding engagement with the outer member, the inner member has a lock hole for alignment with the series of holes in the first lateral side and second lateral side of the outer member;
an end cap fitted on one end of the inner member, the end cap including a foot extending beyond the first lateral side of the outer member when the inner member and outer member are engaged; and
a fastening mechanism press-fit inside the inner member, the fastening mechanism includes a push pin, which is capable of simultaneously extending through the lock hole of the inner member and one hole of the outer member.

9. A device as set forth in claim 1, wherein the foot has a rectangular shape.

10. A device as set forth in claim 2, wherein the inner member and the outer member are block-shaped, having a square cross-section.

11. A device as set forth in claim 1, wherein the device has an axis, the push pin extends through one of the holes of the first lateral side, the inner member and the outer member are separable upon engagement of the push-pin to enable axial rotation of the outer member with respect to the inner member so that re-engaging the outer member with the inner member aligns the push pin with one hole of the second lateral side of the inner member.

12. A device as set forth in claim 4, wherein the fastening device includes a spring loaded clip for pressing biasing the push pin through the lock hole, whereby depression of the push pin towards the axis enables the outer member to slide with respect to the inner member.

13. A device as set forth in claim 4, wherein the fastening device includes a spring loaded clip for pressing biasing the push pin through the lock hole, the clip having a C-shaped cross section.

14. A device as set forth in claim 4, wherein the fastening device includes a spring loaded clip for pressing biasing the push pin through the lock hole, the clip having a C-shaped cross section and two ends, the push pin being configured on one end of the clip.

15. A locking device, comprising:
an outer member having a first lateral side and a second lateral side that opposes the first lateral side, the first lateral side has series of holes spaced apart at a first distance, the second lateral side has a series of holes spaced apart at a second distance, the second distance being less than the first distance to allow fine length adjustment of the locking device;
an inner member in sliding engagement with the outer member, the inner member has a lock hole for alignment with the series of holes in the first lateral side and second lateral side of the outer member;
a first end cap fitted on end of the inner member and a second end cap fitted on one end of the outer member, the first end cap including a foot extending beyond the first lateral side of the outer member when the inner member and outer member are engaged; and
a fastening mechanism attached inside the inner member, the fastening mechanism includes a push pin, which is capable of simultaneously extending through the lock hole of the inner member and one hole of the outer member.

16. A device as set forth in claim 1, wherein the fastening member has a textured surface.

17. A device as set forth in claim 1, wherein the inner member and the outer member are block-shaped, having a square cross-section.

18. A device as set forth in claim 1, wherein the device has an axis, the push pin extends through one of the holes of the first lateral side, the inner member and the outer member are separable upon engagement of the push-pin to enable axial rotation of the outer member with respect to the inner member so that re-engaging the outer member with the inner member aligns the push pin with one hole of the second lateral side of the inner member.

19. A device as set forth in claim 4, wherein the fastening device includes a spring loaded clip for pressing biasing the push pin through the lock hole, whereby depression of the push pin towards the axis enables the outer member to slide with respect to the inner member.

20. A device as set forth in claim 4, wherein the fastening device includes a spring loaded clip for pressing biasing the push pin through the lock hole, the clip having a C-shaped cross section.

21. A locking device comprising:
an outer member and an inner member, the inner member slidably engages with the outer member, the inner member being axially rotatable with respect to the outer member;
the outer member having a length and a periphery defining an opening along a portion of the length, the outer member includes an edge with gaps aligned along the edge;
the inner member has a fastening member extending from the inner member; and
whereby rotation of the inner member with respect to the outer member enables the fastening member to lock against a gap to hold the inner member with respect to the outer member.
